(19) United States
(12) Patent Application Publication
(10) Pub. No.: US 2024/0417211 A1
(43) Pub. Date: Dec. 19, 2024

(54) ASSISTING APPARATUS AND RECORDING APPARATUS

(71) Applicant: CANON KABUSHIKI KAISHA, Tokyo (JP)

(72) Inventors: JUNICHI OCHI, Shizuoka (JP); MASAHIRO SUGIMOTO, Kanagawa (JP); TAKUMA NAKAMURA, Tokyo (JP); YUICHIRO YANAGI, Chiba (JP); KOTA KAWASAKI, Kanagawa (JP); SUGURU TATSUNOKUCHI, Kanagawa (JP)

(21) Appl. No.: 18/737,986

(22) Filed: Jun. 8, 2024

(30) Foreign Application Priority Data
Jun. 16, 2023 (JP) 2023-099530

(51) Int. Cl. B65H 75/24

(52) U.S. Cl. CPC B65H 75/241; B65H 2301/414; B65H 2405/45

(57) ABSTRACT

An assisting apparatus includes: a shaft member that is insertable into a winding core of a roll around which a sheet is wound; a moving member movable in a vertical direction, the moving member including the shaft member; and a detector configured to detect a position of the moving member in the vertical direction. The assisting apparatus is configured to assist in an operation of aligning a position of the roll in the vertical direction in a state in which the shaft portion is inserted in the winding core. The assisting apparatus includes a notifier configured to provide a notification when the detector detects that a position of the moving member in the vertical direction reaches a predetermined target position.

### BACKGROUND OF THE INVENTION

### Field of the Invention

The present invention relates to an assisting apparatus that assists in adjusting the position of a roll around which a sheet is wound, and a recording apparatus that performs recording on a sheet.

### Description of the Related Art

With a recording apparatus that performs recording on a roll around which a sheet is wound, a roll is attached by inserting a rotation shaft into the winding core of the roll from the end of the rotation shaft that is opposite to the end fixed to the recording apparatus main body. To attach a roll, a roll loaded on a loading apparatus, which is separate from the recording apparatus and has a lifting function, is moved to the recording apparatus, and then an operation is needed to align the winding core of the roll with the rotation shaft while lifting and lowering the roll.

This operation is performed while the operator visually checks the positional relationship between the roll and the rotation shaft. As such, depending on the shape of the apparatus, the operator may have to squat down and adjust the height while peering around the rotation shaft. This may be physically demanding. Additionally, when the loading apparatus is configured to support the outer circumference surface of a roll, the height of the winding core varies depending on the winding diameter of the roll, so that an alignment operation is needed every time the roll is changed.

In Japanese Patent Application Publication No. 2008-63117, an axial end portion of the winding core of a roll protrudes from an end portion of the roll, and a dedicated lifting apparatus is used to support this protruding section of the winding core. A sensor is used to measure a predetermined section of the lifting apparatus, so that the alignment is performed irrespective of the roll winding diameter.

The method disclosed in Japanese Patent Application Publication No. 2008-63117 requires the winding core protruding beyond the media width and also requires a dedicated lifting apparatus. This method therefore has limitations in terms of versatility. Additionally, in Japanese Patent Application Publication No. 2008-63117, the alignment of the roll and the rotation shaft is performed in both the right-left direction (horizontal direction) and the up-down direction (vertical direction) as viewed in the axial direction. This requires a complicated alignment mechanism and control, and a relatively long alignment time.

### SUMMARY OF THE INVENTION

The present invention provides an assisting apparatus for simplifying the operation of position adjustment when a roll is attached to a rotation shaft of a roll using apparatus.

The present invention is an assisting apparatus comprising:
a shaft member that is insertable into a winding core of a roll around which a sheet is wound;
a moving member movable in a vertical direction, the moving member including the shaft member; and
a detector configured to detect a position of the moving member in the vertical direction, wherein
the assisting apparatus is configured to assist in an operation of aligning a position of the roll in the vertical direction in a state in which the shaft member is inserted in the winding core, and
the assisting apparatus further comprises a notifier configured to provide a notification when the detector detects that the position of the moving member in the vertical direction reaches a predetermined target position.

Further features of the present invention will become apparent from the following description of exemplary embodiments with reference to the attached drawings.

### BRIEF DESCRIPTION OF THE DRAWINGS

FIG. 1 is a main cross-sectional view illustrating a printing apparatus of an embodiment;

FIG. 2 is a perspective view illustrating a web roll of an embodiment;

FIG. 3 is a perspective view illustrating an unwinding shaft of the printing apparatus of an embodiment;

FIG. 4 is a perspective view illustrating a web roll lifting apparatus of an embodiment;

FIG. 5 is a perspective view illustrating a state in which the web roll of an embodiment is loaded on the lifting apparatus;

FIG. 6 is a perspective view illustrating an assisting apparatus of a first embodiment;

FIG. 7 is a perspective view illustrating how the assisting apparatus of the first embodiment is used;

FIG. 8 is a side view illustrating another shape of a winding core insertion portion of the assisting apparatus of the first embodiment;

FIG. 9 is a perspective view illustrating height alignment of the web roll in the first embodiment;

FIGS. 10A to 10C are side views illustrating a detection operation of the assisting apparatus of the first embodiment;

FIG. 11 is a flowchart illustrating a light emitting operation of the assisting apparatus of the first embodiment;

FIG. 12 is a side view illustrating floor surface illumination of the assisting apparatus of the first embodiment;

FIG. 13 is a perspective view illustrating the operation of attaching a web roll of an embodiment to the unwinding shaft of the printing apparatus;

FIG. 14 is a perspective view illustrating an assisting apparatus of a second embodiment;

FIG. 15 is a side view illustrating the assisting apparatus of the second embodiment;

FIG. 16 is a perspective view illustrating an assisting apparatus of a third embodiment;

FIG. 17 is a perspective view illustrating how the assisting apparatus of the third embodiment is used;

FIG. 18 is a cross-sectional view illustrating a detection operation of the assisting apparatus of the third embodiment;

FIG. 19 is a cross-sectional view illustrating a detection operation of the assisting apparatus of the third embodiment;

FIG. 20 is a diagram illustrating a web roll height or depth position notification mechanism of a fourth embodiment;

FIG. 21 is a diagram of a monitor screen of a web roll height position notification mechanism of the fourth embodiment;

FIG. 22 is a diagram of a monitor screen of a web roll depth position notification mechanism of the fourth embodiment;

FIG. 23 is a diagram of a monitor screen of the web roll depth position notification mechanism of the fourth embodiment;

FIG. 24 is a diagram of a monitor screen of a web roll height position notification mechanism of a fifth embodiment;

FIG. 25 is a diagram of a monitor screen of the web roll depth position notification mechanism of the fifth embodiment;

FIG. 26 is a diagram illustrating an advantageous effect of an embodiment;

FIG. 27 is a diagram illustrating an advantageous effect of an embodiment;

FIG. 28 is a diagram illustrating an advantageous effect of an embodiment; and

FIG. 29 is a diagram illustrating an advantageous effect of an embodiment.

### DESCRIPTION OF THE EMBODIMENTS

### First Embodiment

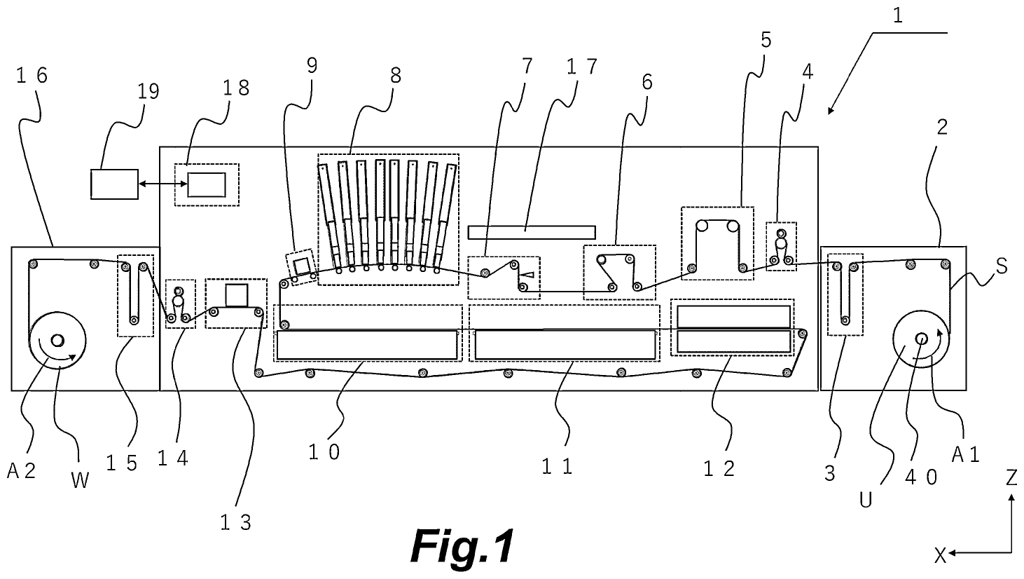

An embodiment of the present invention is specifically described below with reference to the drawings. FIG. 1 is a schematic cross-sectional view showing the internal configuration of a printing apparatus 1, which is a recording apparatus. The right-left directions in FIG. 1 are X directions, the directions perpendicular to the drawing plane of FIG. 1 are Y directions, and the up-down directions are the Z directions. The X directions are horizontal directions as viewed from the front of the printing apparatus 1, and the direction from right to left in FIG. 1 is defined as positive. The Y directions are the sheet width directions that are perpendicular to the conveyance direction of the sheet S, and the direction from the frontward to the rearward with respect to the drawing plane is defined as positive. As for the Z directions, the direction toward the top of the printing apparatus 1 is defined as positive.

The printing apparatus 1 of the first embodiment is a high-speed inkjet line printer of what is known as a roll-to-roll system, which unwinds a continuous sheet wound into a roll, that is, a web roll, and winds it into a roll after printing. The inkjet process is a process of forming an image with dots by spraying minute ink droplets onto a sheet. It should be noted the present invention is applicable to any printing apparatus that performs unwinding from a roll, and the image forming process is not limited to the inkjet process. For example, the present invention is also applicable to an electrophotographic image forming apparatus. For example, in the case of a full-color laser beam printer, the electrophotographic process refers to an image formation process in which toner of Bk, C, M, and Y colors is developed on an electrostatic latent image formed on a photosensitive member, and the toner image is transferred to a sheet using a transfer belt or the like and is then thermally fixed by a fixing apparatus.

The printing apparatus 1 includes units of an unwinder unit 2, a first dancer portion 3, a first main conveyance portion 4, a meandering correction portion 5, a conveyance detection portion 6, a mark sensor portion 7, a recording portion 8, a first scanner portion 9, a first drying portion 10, a second drying portion 11, a cooling portion 12, a second scanner portion 13, a second main conveyance portion 14, a second dancer portion 15, a winder unit 16, a maintenance portion 17, and a control portion (controller) 18. The sheet S is unwound from a web roll U, conveyed along a sheet conveyance path shown by a solid line in the figure, processed by each unit, and then wound up by a winding roll W. The control portion 18 controls the operation of each unit of the printing apparatus 1. The control portion 18 receives print commands, image data, and the like from an external host computer 19, and controls the printing apparatus 1 on the basis of them. The control portion 18 includes a volatile memory and a nonvolatile memory, which are used as storage areas for programs for performing various processes and image data obtained from the external host computer 19.

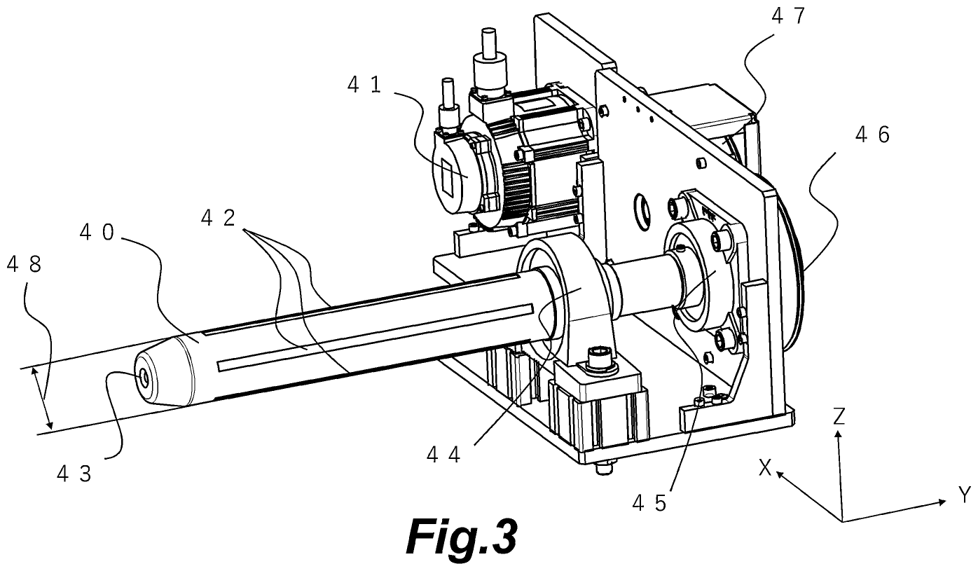

The unwinder unit 2 holds the web roll U and supplies the sheet S from the web roll U to the conveyance path. The unwinder unit 2 includes an unwinding shaft 40, to which the web roll U is attached. The unwinding shaft 40 is rotated by a motor 41 (see FIG. 3) in the direction of arrow Al so that the sheet S is pulled out and supplied to the conveyance path. The first embodiment is an example of a configuration in which the printing apparatus 1 includes one web roll U, but the number of web rolls is not limited to one. The printing apparatus 1 may be configured to be able to accommodate multiple unwinding rolls, and the sheet S may be drawn out from one roll selected from the multiple rolls and supplied to the conveyance path.

The winder unit 16 winds the sheet S on which recording is performed around a winding core, which is rotated by a motor (not shown) in the direction of arrow A2 to wind the sheet S. Although the first embodiment exemplifies a configuration in which the printing apparatus 1 includes one winding roll W, the number of winding rolls is not limited to one. The printing apparatus 1 may include multiple winding cores (winding rolls), and the sheet S may be collected onto one winding core selected from the multiple winding cores. Depending on the post-recording processing, instead of a configuration that winds the sheet around the winding core, a configuration may be used that cuts the continuous sheet with a cutter (not shown) and stacks the cut sheets S.

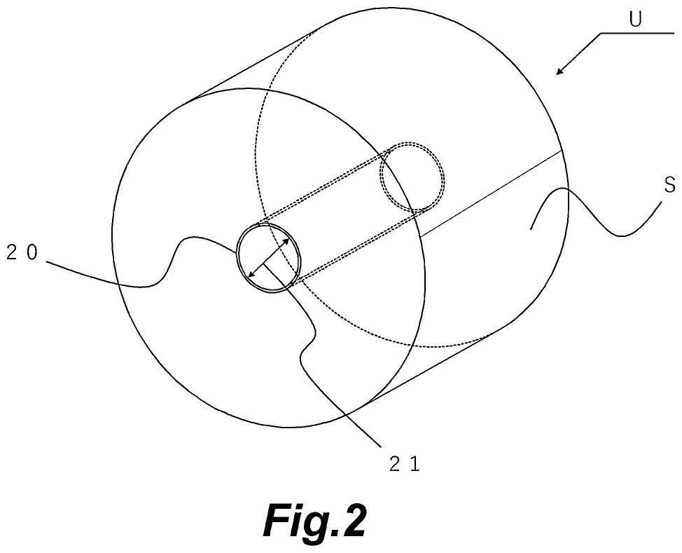

As shown in FIG. 2, the web roll U includes a sheet S wound around a hollow winding core 20. The winding core 20 of the first embodiment has an inner diameter 21 of 3 inches and a thickness of about 5 mm, is made of hard paper, and has a cylindrical shape. The axial length of the winding core 20 is the same as the sheet width, and is generally about 80 mm to 360 mm for inkjet line printers. The winding core 20 may be made of resin, and the inner diameter and thickness are not limited to the above examples. Examples of the material of the sheet S include plain paper, inkjet paper, special paper, resin film such as polyester film, and label paper in which an adhesive layer and release paper are affixed. The winding length of the sheet S may be as long as several thousand meters. Diameters ranging from several tens of centimeters to about one meter are often used.

FIG. 3 is a diagram showing the driving section extracted to illustrate the details of the unwinding shaft 40 of the unwinder unit 2. The driving section of the unwinding shaft 40 and the driving section of the winding shaft are symmetrical in shape and have substantially the same components. The description of the winding shaft is therefore omitted. The unwinder unit 2 forms the printing apparatus 1, which is a roll using apparatus that uses the web roll U. The unwinding shaft 40 is a rotation shaft insertable into the winding core 20 of the web roll U. The unwinder unit 2 of the printing apparatus 1 can be used in a state in which the web roll U is attached to the unwinding shaft 40.

The unwinding shaft 40 is a metal shaft having a chuck function, and is generally referred to as an air shaft. The winding core insertion portion of the unwinding shaft 40 has a shaft diameter 48 that is smaller than the inner diameter 21 by 1 to 2 mm, enabling the insertion and removal with respect to the winding core 20 without any interference. When compressed air is blown into the unwinding shaft 40 through an air valve 43 using an air gun (not shown), chuck members 42, which may be referred to as lugs or strips, protrude from the circumference surface of the shaft and come into contact with the inner circumference surface of the winding core 20, thereby holding the winding core 20 by air pressure. To remove the winding core 20, the air valve 43 is operated to remove the compressed air, thereby releasing the chuck members 42. The same effect can be achieved by a configuration in which the chuck members are pushed out using a mechanical configuration instead of air pressure. The unwinding shaft 40 is held in a cantilevered manner by bearings 44 and 45, and a pulley 46 is provided at the end of the unwinding shaft 40 on the side corresponding to the bearings 44 and 45. The pulley 46 and the motor 41 are connected by a toothed belt 47, which provides reduction gearing.

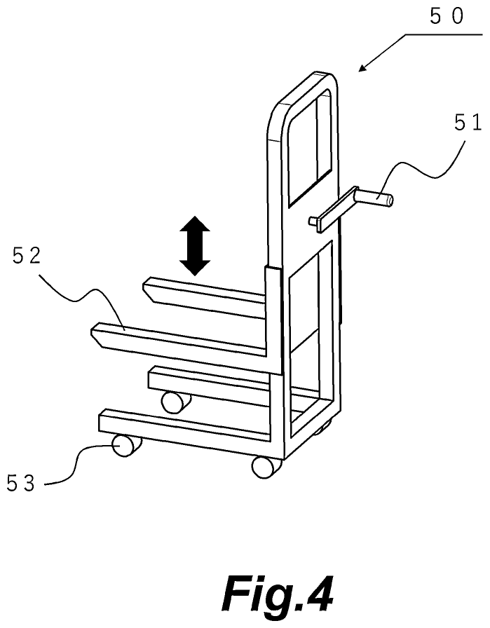

FIG. 4 shows an example of a lifting apparatus for the web roll U. The lifting apparatus may generally be referred to as a lifter. As indicated by the arrows in the figure, the lifting apparatus 50 is configured such that a loading portion 52 ascends when a handle 51 is rotated clockwise, and descends when the handle 51 is rotated counterclockwise. The position of the loading portion 52 is maintained even after the handle 51 is released. In another illustrative configuration not shown, the loading portion 52 may be lifted and lowered by hydraulic pressure when a lever is operated. The lifting apparatus 50 can easily lift a heavy object that is less than a predetermined load capacity.

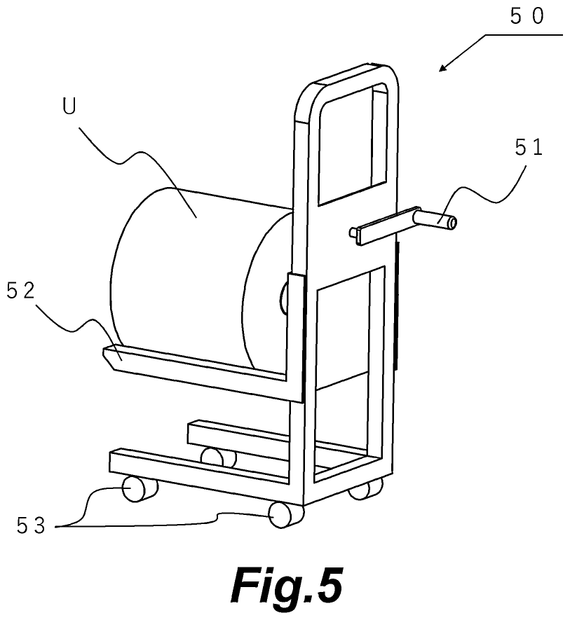

FIG. 5 is a diagram showing a state in which the web roll U is loaded on the lifting apparatus 50. Since the lifting apparatus 50 includes casters 53, it can move with the web roll U loaded thereon as shown in FIG. 5.

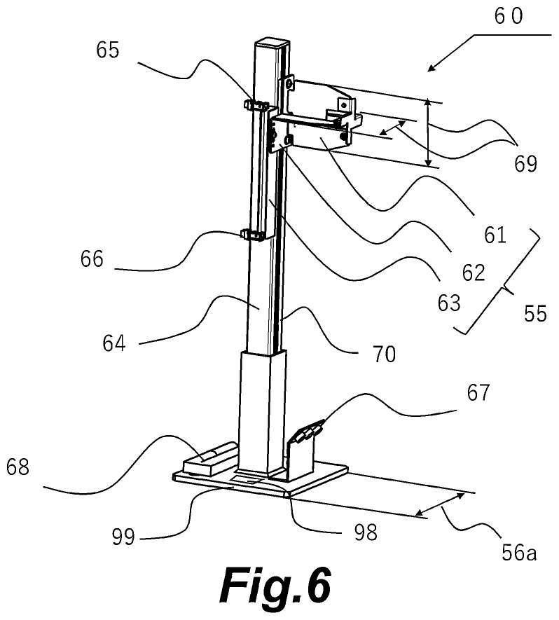

FIG. 6 is a diagram showing an assisting apparatus for detecting the height of the web roll U in the first embodiment. The assisting apparatus 60 may include a winding core insertion portion 61, a slide portion 62, a sensor flag 63, a support column 64 as a support member, an upper sensor 65 and a lower sensor 66 as detector, a light emitting member 67 as a notifier, a dry battery 68, and a control portion 98, for example. The assisting apparatus 60 assists the operator in vertically aligning the web roll U in a state in which the winding core insertion portion 61 is inserted in the winding core 20. The winding core insertion portion 61, the slide portion 62, and the sensor flag 63 are integrally formed and serve as a movable member 55. The winding core insertion portion 61 is a shaft member insertable into the winding core 20 of the web roll U. The slide portion 62 is a moving member that can integrally slide along a groove 70 of the support column 64 and move in the vertical direction. The winding core insertion portion 61 is provided on the slide portion 62. The support column 64 is a support member that supports the slide portion 62 so as to be movable in the vertical direction. The upper sensor 65 and the lower sensor 66 are detector for detecting the position of the movable member 55 in the vertical direction. The light emitting member 67 is a notifier that provides a notification according to the detection results by the upper sensor 65 and the lower sensor 66. In the first embodiment, the light emitting member 67 provides a notification by light when the upper sensor 65 and the lower sensor 66 detect that the vertical position of the movable member 55 has reached a predetermined target position. The target position is a position of the movable member 55 that corresponds to a position in the vertical direction of the web roll U at which the inner circumference surface of the winding core 20 of the web roll U and the outer circumference surface of the unwinding shaft 40 do not interfere with each other. A stopper (not shown) is provided in the groove 70 to limit the range in which the slide portion 62 can slide to a necessary and sufficient range. In the first embodiment, the assisting apparatus 60 is configured to be able to be carried independently of the printing apparatus 1, but the support column 64 may be configured as a part of the printing apparatus 1, for example. Also, the power source for the upper sensor 65, the lower sensor 66, and the light emitting member 67 is not limited to the dry battery 68. A protective cover (not shown) is attached to the outside of the upper sensor 65 and the lower sensor 66.

The winding core insertion portion 61 is formed by combining two metal sheets in a cross shape. The dimension of width across flats 69 of parallel sections of the winding core insertion portion 61 is smaller than the inner diameter 21 by about 0.5 to 1 mm. The material of the winding core insertion portion 61 is not limited to metal, and resin or other materials may also be used. Additionally, the shape is not limited to the above example, and may be a conical shape or a cylindrical shape with a tapered distal end.

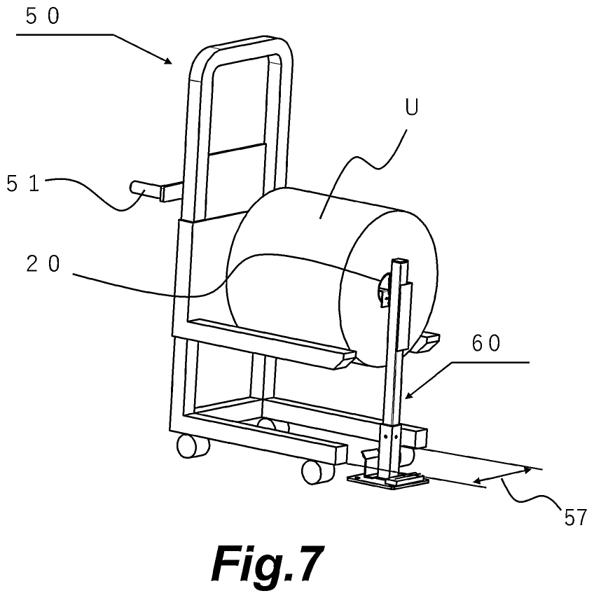

The support column 64 includes a seat surface 99, which allows the support column 64 to stand on its own in the vertical direction when placed on a floor surface. Casters may be attached to the lower surface of the seat surface 99. The seat surface 99 has a width 56a that is less than a frame width 57 of the lifting apparatus 50 (see FIG. 7), and therefore does not come into contact with the lifting apparatus 50 when the assisting apparatus 60 is attached to the web roll U.

The upper sensor 65 and the lower sensor 66 are a first photo interrupter and a second photo interrupter, which are located at different vertical positions. The sensor flag 63 is integral with the slide portion 62 together with the winding core insertion portion 61 as the movable member 55. As such, a change in the height of the winding core insertion portion 61 changes the position of the sensor flag 63 in the Z direction. The sensor flag 63 is configured to be capable of passing between the light emitting portion and the light receiving portion of each of the upper and lower sensors 65 and 66. The sensor flag 63 serves as a blocking portion that is capable of blocking the light emitting portion and the light receiving portion of the upper sensor 65 or the lower sensor 66 depending on its vertical position. When the sensor flag 63 is present between a light emitting portion and a light receiving portion, the sensor flag 63 interrupts the light from the light emitting portion, causing a change in the output of the light receiving portion as compared with when the sensor flag 63 is not present between the light emitting portion and the light receiving portion. This allows the upper sensor 65 and the lower sensor 66 to detect whether the sensor flag 63 is present at the position of the sensor.

By adjusting the positions of the upper sensor 65, the lower sensor 66, or the sensor flag 63 to the desired positions in advance, the upper sensor 65 or the lower sensor 66 can operate at the height that needs to be detected. The detection results of the upper and lower sensors 65 and 66 are input to the control portion 98. The control portion 98 is a controller that controls the light emission of the LEDs forming the light emitting member 67 according to the detection results of the upper and lower sensors 65 and 66. The light emitting member 67 can emit light in different colors. In the first embodiment, the light emitting member 67 uses three LEDs that emit light of different colors. The control portion 98 causes the LEDs of different colors to emit light according to the detection results of the upper and lower sensors 65 and 66. The dry battery 68 is mounted as the power source for the upper sensor 65, the lower sensor 66, the control portion 98, and the light emitting member 67, and a power switch (not shown) is turned on before use.

FIG. 7 is a diagram showing a state in which the assisting apparatus 60 is attached to the web roll U. The winding core insertion portion 61 of the assisting apparatus 60 is configured to be insertable into the winding core 20 of the web roll U placed on the lifting apparatus 50. In the example of FIG. 7, the assisting apparatus 60 is configured independently of the lifting apparatus 50. The winding core insertion portion 61 (see FIG. 6) is inserted into the portion defining the inner diameter 21 (see FIG. 2) of the web roll U loaded on the lifting apparatus 50. As illustrated in FIG. 6, the movable member 55 including the winding core insertion portion 61 can slide to move. As such, the operator can easily attach the assisting apparatus 60 by lifting the movable member 55 to adjust the height according to the height of the web roll U loaded on the lifting apparatus 50.

The winding core insertion portion 61 is sized to be slightly smaller than the inner diameter 21 and has a tapered shape with the corners at the distal end diagonally cut off. Thus, the winding core insertion portion 61 can be smoothly inserted and removed while preventing significant play. When the handle 51 of the lifting apparatus 50 is rotated from this state to raise or lower the height of the web roll U, the movable member 55 of the assisting apparatus 60 follows the web roll U and moves up or down.

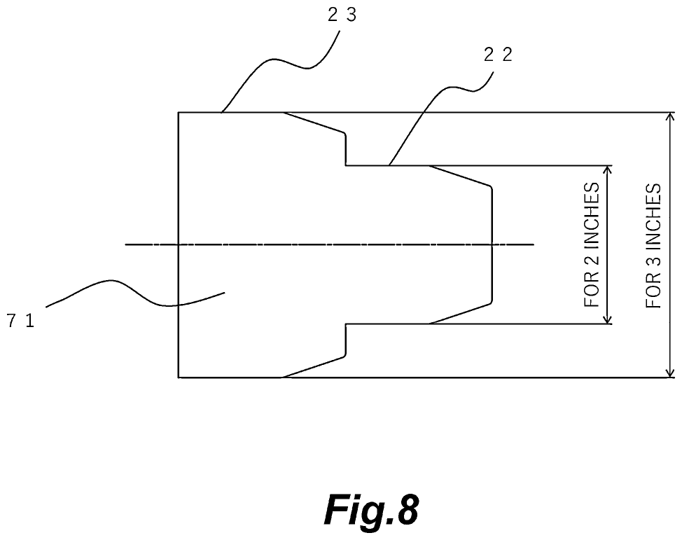

FIG. 8 is a diagram showing a different embodiment of the winding core insertion portion 61 of the assisting apparatus 60. FIG. 8 is a side view of the winding core insertion portion 61 of the assisting apparatus 60. The winding core insertion portion 61 may have a tapered shape in which the outer diameter increases in the direction in which it is inserted into the winding core 20. Furthermore, the winding core insertion portion 61 may have a stepped shape formed by multiple sections having different outer diameters. In the example shown in FIG. 8, the winding core insertion portion 71 has a stepped shape. The winding core insertion portion 71 is thus usable with multiple types of winding cores with different inner diameter dimensions. The winding core insertion portion 71 illustrated in FIG. 8 includes a first section 22, which has a width across flats corresponding to a winding core having an inner diameter of 2 inches, and a second portion 23, which has a width across flats corresponding to a winding core having an inner diameter of 3 inches. The first and second sections 22 and 23 are integrally formed. As a result, one assisting apparatus 60 is usable with multiple types of winding cores having different inner diameters.

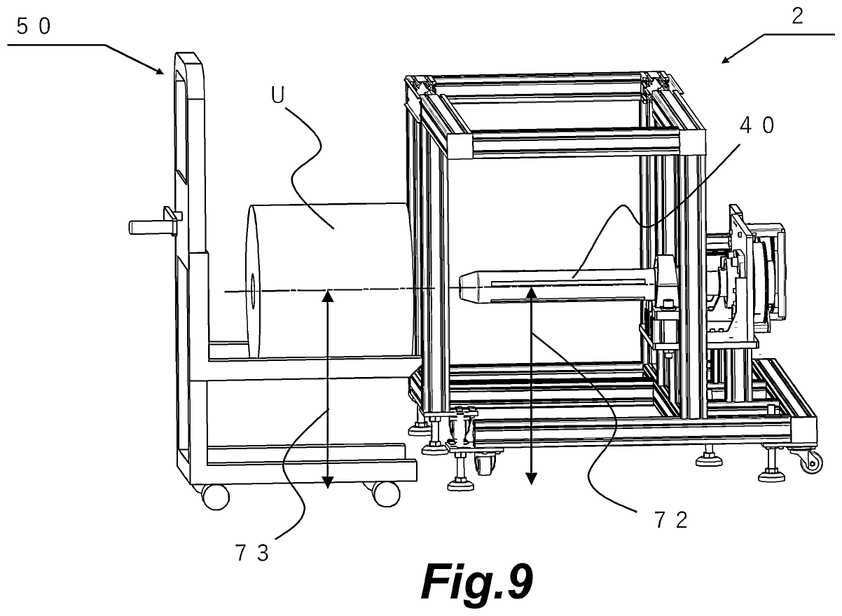

FIG. 9 is a diagram showing a state in which the lifting apparatus 50 carrying the web roll U is brought closer to the unwinder unit 2 to attach the web roll U to the unwinding shaft 40 of the unwinder unit 2. As shown in FIG. 9, the height 72 of the unwinding shaft 40 of the unwinder unit 2 is a fixed dimension. To attach the web roll U to the unwinding shaft 40, the lifting apparatus 50 and the assisting apparatus 60 are used to adjust the center height 73 of the web roll U on the lifting apparatus 50 to be equal to the height 72 of the unwinding shaft 40 in advance. This facilitates the attachment of the web roll U to the unwinding shaft 40. Operation efficiency is improved by adjusting the center height 73 of the web roll U at a location away from the printing apparatus 1, then moving the lifting apparatus 50 to the printing apparatus 1, and inserting the unwinding shaft 40 into the web roll U.

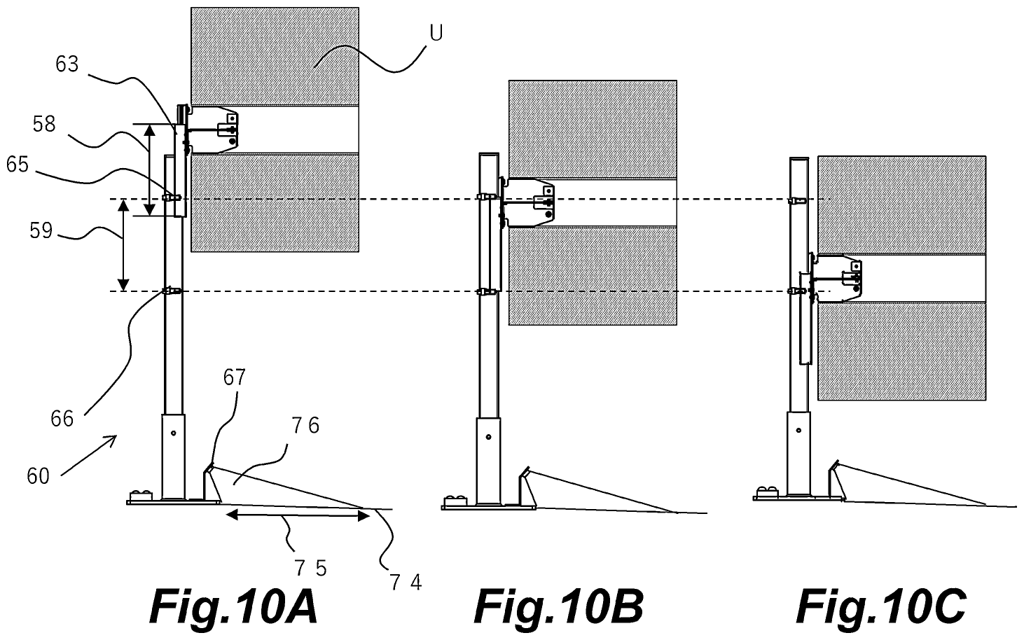

FIGS. 10A to 10C are diagrams showing positional relationships between the upper sensor 65, the lower sensor 66, and the sensor flag 63. FIGS. 10A to 10C are side views of the assisting apparatus 60 and show a cross section of the web roll U. FIG. 10A shows a state in which the position of the web roll U is higher than the target position, FIG. 10B shows a state in which the web roll U is at the target position, and FIG. 10C shows a state in which the position of the web roll U is lower than the target position. The upper sensor 65 and the lower sensor 66 are ON when the sensor flag 63 blocks between the light emitting portion and the light receiving portion (detection portion) of each sensor (photo interrupter), and OFF when the sensor flag 63 does not block them. The positions of the upper and lower sensors 65 and 66 and the dimensions of the sensor flag 63 are set such that the upper and lower sensors 65 and 66 are both OFF when the web roll U is at the target position as shown in FIG. 10B. The length of the sensor flag 63 in the vertical direction is shorter than the distance between the upper and lower sensors 65 and 66 in the vertical direction. In the first embodiment, the distance 59 between the upper and lower sensors 65 and 66 is greater than the length 58 in the up-down direction of the sensor flag 63 by about 2 mm, so that the position of the web roll U in the height direction is adjustable within a range of ±1 mm.

When the position of the web roll U moves up or down from the target position shown in FIG. 10B, the state shifts to the state shown in FIG. 10A or FIG. 10C. While the web roll U moves up from the target position of FIG. 10B to the position corresponding to the maximum height that the lifting apparatus 50 can lift the web roll U, the upper sensor 65 is ON and the lower sensor 66 is OFF. The maximum height that the lifting apparatus 50 can lift the web roll U is determined by the specifications of the lifting apparatus 50. As such, the width 58 of the sensor flag 63 is set such that the upper sensor 65 is ON and the lower sensor 66 is OFF as shown in FIG. 10A while the web roll U is moved beyond the target position of FIG. 10B to a position at which the web roll U is determined to be noticeably too high.

The width 58 of the sensor flag 63 is set such that the upper sensor 65 is OFF and the lower sensor 66 is ON, while the web roll U is moved down from the target position of FIG. 10B to the lowest position that the lifting apparatus 50 can lower the web roll U.

In the states of FIGS. 10A, 10B, and 10C, the combinations of the detection results of the upper and lower sensors 65 and 66 are as follows.
FIG. 10A (higher than target position) Upper sensor 65: ON, lower sensor 66: OFF
FIG. 10B (at target position) Upper sensor 65: OFF, lower sensor 66: OFF
FIG. 10C (lower than target position) Upper sensor 65: OFF, lower sensor 66: ON

When the movable member 55 is at the target position, the sensor flag 63 does not block either the upper sensor 65 or the lower sensor 66. When the movable member 55 is at a position higher than the target position or lower than the target position, the sensor flag 63 blocks one of the upper sensor 65 and the lower sensor 66. In this case, the upper and lower sensors 65 and 66 are configured to be able to detect a state in which the movable member 55 is at the target position, a state in which the movable member 55 is at a position higher than the target position, and a state in which the movable member 55 is at a position lower than the target position.

The control portion 98 causes the LEDs of the light emitting member 67 to emit light in a different color according to the combination of the detection results of the upper and lower sensors 65 and 66. That is, the light emitting member 67 provides a notification by emitting light in different colors between a state in which the position of the movable member 55 is at the target position and another state. For example, in the states shown in FIGS. 10A, 10B, and 10C, the control portion 98 causes the LEDs of yellow, green, and red, respectively, of the light emitting member 67 to emit light. The operator looks at this color, determines the height of the web roll U, and aligns the height. The LEDs forming the light emitting member 67 are installed so that the illumination light 76 illuminates an illumination area 75 on the floor surface 74 of the space in which the assisting apparatus 60 is set. This improves the visibility of the color of light emitted by the LEDs of the light emitting member 67.

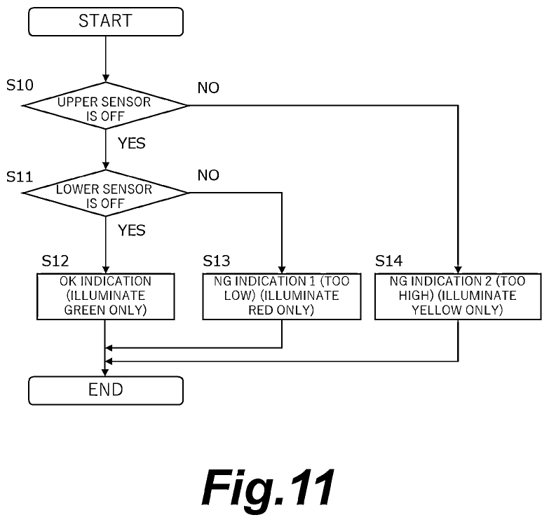

FIG. 11 is a flowchart showing the light emission control of the LEDs of the light emitting member 67 performed by the control portion 98 of the assisting apparatus 60.

At step S10, the control portion 18 obtains the detection result of the upper sensor 65. Here, the control portion 18 determines whether the detection result of the upper sensor 65 is OFF. If the detection result of the upper sensor 65 is OFF (step S10: YES), step S11 is performed. If it is ON (step S10: NO), step S14 is performed.

At step S11, the control portion 18 obtains the detection result of the lower sensor 66. Here, the control portion 18 determines whether the detection result of the lower sensor 66 is OFF. If the detection result of the lower sensor 66 is OFF (step S11: YES), step S12 is performed. If it is ON (step S11: NO), step S13 is performed. At step S12, the control portion 18 causes the green LED to emit light. At step S13, the control portion 18 causes the red LED to emit light. At step S14, the control portion 18 causes the yellow LED to emit light.

With the above light emission control, when both the upper sensor 65 and the lower sensor 66 are OFF (the state shown in FIG. 10B), for example, the green LED lights up. When the upper sensor 65 is OFF and the lower sensor 66 is ON (the state shown in FIG. 10C), the red LED lights up. When the upper sensor 65 is ON (FIG. 10A), the yellow LED lights up.

The order of determination at step S10 and step S11 is not limited to the above example. Also, the light emission control of the LEDs may be performed by referring to a table that defines the correspondence between the combinations of the determination results of the upper sensor 65 and the lower sensor 66 and the emission colors of the LEDs. Alternatively, the light emission pattern of an LED of one color may be controlled according to the combination of detection results of the upper and lower sensors 65 and 66. That is, the light emitting member 67 may be capable of emitting light in multiple different patterns, and the notification may be made by emitting light in different patterns between a state in which the position of the movable member 55 is at the target position and another state. For example, lighting and blinking of the LED may be combined, or blinking intervals may be different.

The illumination area 75 of the light emitting member 67 is not limited to the floor surface 74 of the space in which the assisting apparatus 60 is set. For example, it may be set on a ceiling or a wall surface, in accordance with the work environment. A configuration in which the LED of the light emitting member 67 illuminates the floor surface, ceiling, or a wall surface is advantageous especially when the web roll U has a large diameter. This is because the light emitting member 67 may be hidden behind the web roll U and cannot be seen directly when the attached assisting apparatus 60 and the operator are on opposite sides of the web roll U.

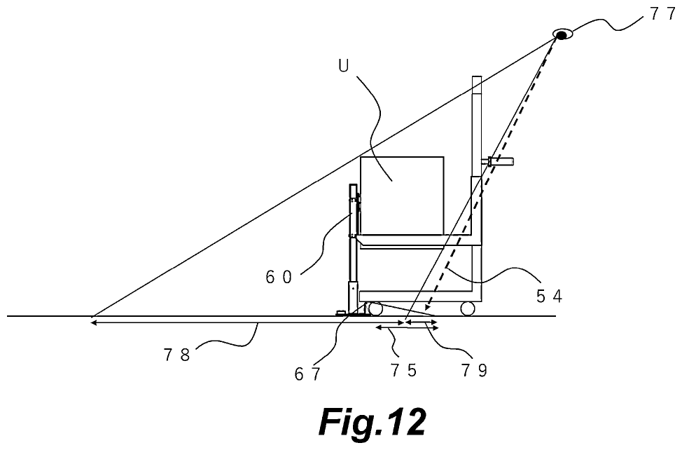

FIG. 12 is a diagram showing a state in which the assisting apparatus 60 and the operator are located on opposite sides of the web roll U. From the operator's viewpoint 77, there is an invisible area 78 hidden by the web roll U. The light emitting member 67 is in this invisible area 78. However, even if the light emitting member 67 cannot be directly seen, a section 79 of the illumination area 75 on the floor surface is within the visible area as indicated by the line of sight 54. This allows the operator to determine the height of the web roll U by looking at the color of the light that is emitted by the LED and reflected on the floor surface.

The means of notifying the operator of the detection results of the upper and lower sensors 65 and 66 is not limited to the light emitting member 67. For example, a sound emitting member may be suitably used that sounds different beeps or melodies depending on the detection results of the upper and lower sensors 65 and 66. When the sound emitting member is used for the notification of detection result, the operator can identify the notification content only through hearing. This is advantageous especially when a large web roll U obstructs the view. Alternatively, a configuration combining sound and light may be used.

The operator sets the assisting apparatus 60 to the web roll U loaded on the lifting apparatus 50, and operates the lifting apparatus 50 while checking the height detection result notified by the light emitting member 67 of the assisting apparatus 60. This allows the operator to adjust the height of the web roll U to the target position. When the height adjustment is completed, the operator removes the assisting apparatus 60 and turns off the power switch (not shown).

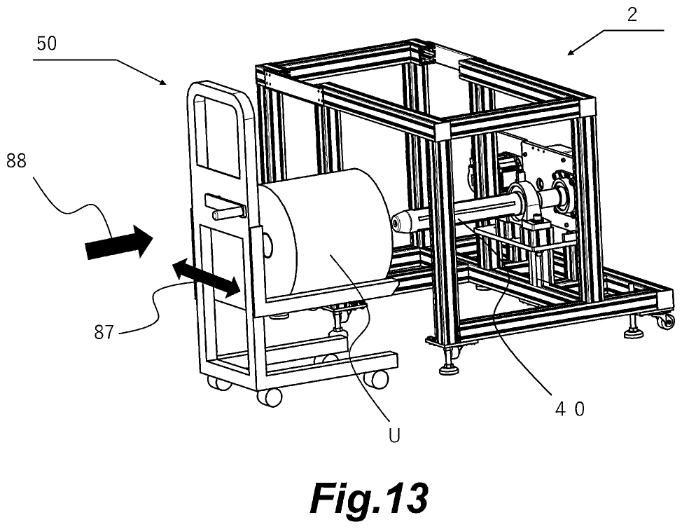

FIG. 13 is a diagram showing a state in which the lifting apparatus 50 carrying the web roll U is brought closer to the unwinder unit 2 to attach the web roll U to the unwinding shaft 40 of the unwinder unit 2. As shown in FIG. 13, the web roll U is brought to the vicinity of the unwinder unit 2 by the lifting apparatus 50, and the position of the web roll U in the right-left direction 87 is roughly adjusted corresponding to the unwinding shaft 40 through visual observation. In this state, the lifting apparatus 50 is pushed in the direction indicated by arrow 88 to bring the web roll U closer to the unwinding shaft 40, and the unwinding shaft 40 is inserted into the web roll U. After pulling out the leading edge of the sheet (not shown), splicing it onto the sheet S remaining in the printing apparatus 1, and adjusting the depth direction of the web roll U, compressed air is injected through the air valve 43 of the unwinding shaft 40 shown in FIG. 3. The attachment is thus complete.

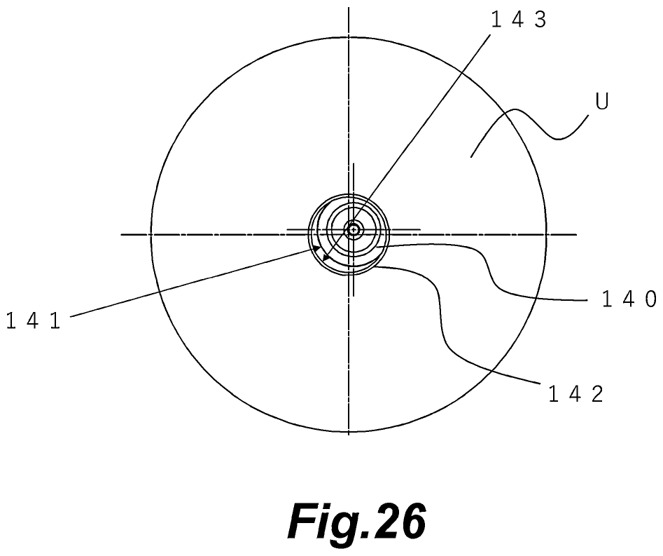

The assisting apparatus 60 of the first embodiment is used to adjust only the height (position in the up-down direction) of the web roll U to the target position. The position in the right-left direction is roughly adjusted by the operator through visual observation as illustrated in FIG. 13. The accurate alignment only in the up-down direction with respect to the unwinding shaft 40 sufficiently improves the ease of attachment of the web roll U to the unwinding shaft 40. The reason for this is described below using two cases of “A. Misaligned in both right-left direction and up-down direction” and “B. Misaligned in right-left direction and aligned in up-down direction” with reference to FIGS. 26, 27, 28, and 29. For the sake of simplicity, it is assumed that the axial direction of the web roll U and the axial direction of the shaft 140 of the unwinder unit are parallel to each other.

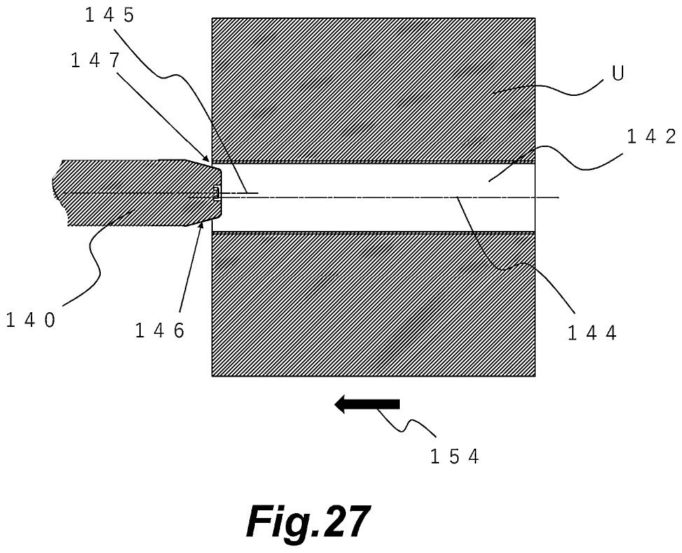

FIGS. 26 and 27 are diagrams illustrating the case of “A. Misaligned in both right-left direction and up-down direction”. FIG. 26 is an axial view of the web roll U showing the positional relationship between the unwinding side web roll U and the shaft 140 of the unwinder unit. FIG. 26 shows a state in which the inner diameter portion 143 of the winding core 142 of the web roll U overlaps the outer diameter portion 141 of the shaft 140 of the unwinder unit diagonally upward to the right. FIG. 27 is a cross-sectional view of the state shown in FIG. 26 as viewed from the left side. As shown in FIG. 27, the shaft 140 of the unwinder unit has a tapered shape 146 at its distal end. This facilitates the insertion into the web roll U even when the central axis 144 of the web roll U is lower than the central axis 145 of the shaft 140 of the unwinder unit in the up-down direction. Nevertheless, when the weight of the web roll U is heavy, it is difficult to push the web roll U in the direction of arrow 154 in FIG. 27 over the contact portion 147 of the tapered shape 146. For this reason, the operator operates the handle of the lifting apparatus (not shown) while visually observing the inner diameter portion 143 of the winding core 142 of the web roll U to align the position in the up-down direction. It is a burdensome task for the operator to perform alignment in the up-down direction while performing alignment in the right-left direction at the same time.

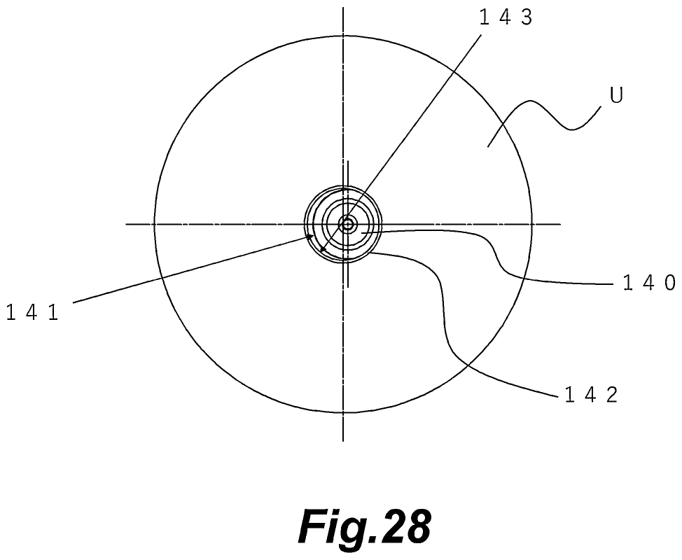

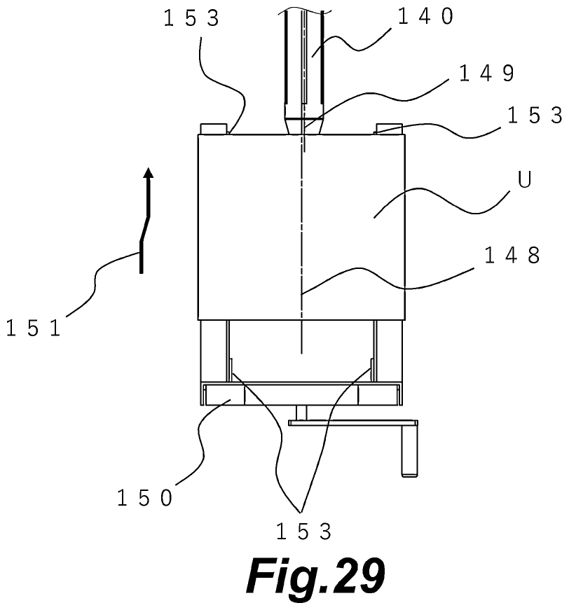

FIG. 28 illustrates the case of “B. Misaligned in right-left direction and aligned in up-down direction”. FIG. 28 is an axial view of the web roll U showing the positional relationship between the web roll U and the shaft 140 of the unwinder unit. FIG. 28 shows a state in which the inner diameter portion 143 of the winding core 142 of the web roll U overlaps the outer diameter portion 141 of the shaft 140 of the unwinder unit in a horizontal direction (right direction). FIG. 29 is a top view showing the positional relationship in FIG. 28 in a state in which the web roll U is loaded on the lifting apparatus 150.

As viewed from above, the central axis 148 of the web roll U is misaligned relative to the central axis 149 of the shaft 140 of the unwinder unit in the horizontal direction, but their center heights in the up-down direction match. As such, when the lifting apparatus 150 is pressed in this position, the casters 153 attached to the lifting apparatus 150 follow. Thus, the lifting apparatus 150 can easily move conforming to the tapered shape, allowing the web roll U to move along the path indicated by arrow 151 to be attached to the shaft 140 of the unwinder unit. In this manner, simply aligning the position in the up-down direction in advance allows the web roll U to be easily attached.

The use of the assisting apparatus 60 of the first embodiment allows the operator to align the height of the web roll U while standing, thereby reducing the physical burden on the operator. Other advantages include a short time to complete the operation and the use of a general-purpose lifting apparatus for aligning the height without requiring a dedicated lifting apparatus. Furthermore, since the height can be aligned in advance for the next job while printing the current job, the time required to change rolls can be shortened, thereby improving productivity.

The upper and lower sensors 65 and 66 provided in the assisting apparatus 60 are not limited to photo interrupters. For example, a sensor that detects the height of the slide portion 62 using a laser or the like may be integrally attached to the slide portion 62, and the detection result of the sensor may be notified in the same manner. Furthermore, the method of notifying the detection results is not limited to the one using the above-mentioned light emitting member or the sound emitting member, and may also use a display apparatus that displays the detection results.

### Second Embodiment

A second embodiment is now described. The second embodiment differs from the first embodiment in the configuration of the assisting apparatus. Configurations similar to those in the first embodiment are not shown in drawings, or are given the same reference numerals in the drawings for description.

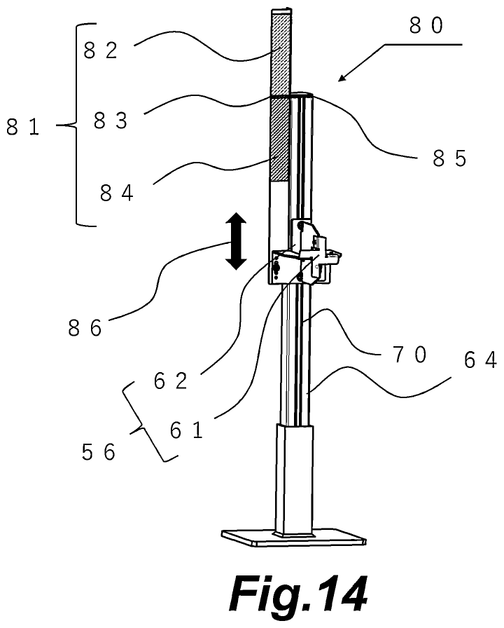

FIG. 14 is a diagram showing an assisting apparatus 80 according to the second embodiment. The assisting apparatus 80 may include a winding core insertion portion 61, a slide portion 62, a support column 64, and an indication portion 81, for example. In the second embodiment, the assisting apparatus 80 is configured to be able to be carried independently of the printing apparatus 1, but the support column 64 may be configured as a part of the printing apparatus 1, for example. The assisting apparatus 80 assists the operator in vertically aligning the web roll U in a state in which the winding core insertion portion 61 is inserted in the winding core 20.

As in the first embodiment, the slide portion 62 is formed integrally with the winding core insertion portion 61 as a movable member 56, which can slide to move along the groove 70 relative to the support column 64. In the same manner as the first embodiment, the winding core insertion portion 61 preferably has a stepped shape to accommodate winding cores of different inner diameters, as shown in FIG. 8. The indication portion 81, which is unique to the second embodiment, is an indicator that indicates the position of the movable member 56 in the vertical direction by moving in conjunction with movement of the movable member 56. The indication portion 81 includes a red indicator 82, a green indicator 83, a yellow indicator 84, and a marking 85 as visible marks so as to indicate that the vertical position of the movable member 56 has reached a predetermined target position. The green indicator 83 is a first mark provided on the movable member 56. The marking 85 is a second mark provided on the support column 64, which is a support member, such that the marking 85 does not move relative to the support column 64. The green indicator 83 and the marking 85 are configured to be aligned with each other when the movable member 56 is at the target position. The red indicator 82 is a third mark that indicates a region higher than the green indicator 83 in the movable member 56 and extends in the vertical direction. The yellow indicator 84 is a fourth mark that indicates a region lower than the green indicator 83 in the movable member 56 and extends in the vertical direction. When the movable member 56 is at a position higher than the target position, the marking 85, which is the second mark, is located within the range of the yellow indicator 84, which is the fourth mark. When the movable member 56 is at a position lower than the target position, the marking 85, which is the second mark, is located within the range of the red indicator 82, which is the third mark. The indication portion 81 is formed integrally with the movable member 56. In the second embodiment, the indication portion 81 is configured to be able to indicate with three different colors of the red indicator 82, the green indicator 83, and the yellow indicator 84.

To use the assisting apparatus 80, the winding core insertion portion 61 is attached to the winding core 20 of the web roll U, and the height of the lifting apparatus 50 is adjusted by lifting or lowering the lifting apparatus 50 in the same manner as in the first embodiment. When the movable member 56 moves up and down in the directions of arrow 86, which are the height directions, the position of the indication portion 81 changes relative to the support column 64. The support column 64 has the marking 85 near its top. The height of the web roll U is determined from the positional relationship between the marking 85 and the indication portion 81 to adjust the height. When the green indicator 83 is at the same height as the marking 85, the web roll U is at the target position. That is, when the web roll U is too low, the red indicator 82 is adjacent to the marking 85. When the web roll U is too high, the yellow indicator 84 is adjacent to the marking 85.

The indication portion 81 is preferably set at a relatively high position to be easily visible to the operator. This is because the indication portion 81 that is at a low height would be hidden behind the web roll U and cannot be seen directly when the attached assisting apparatus 80 and the operator are on opposite sides of the web roll U.

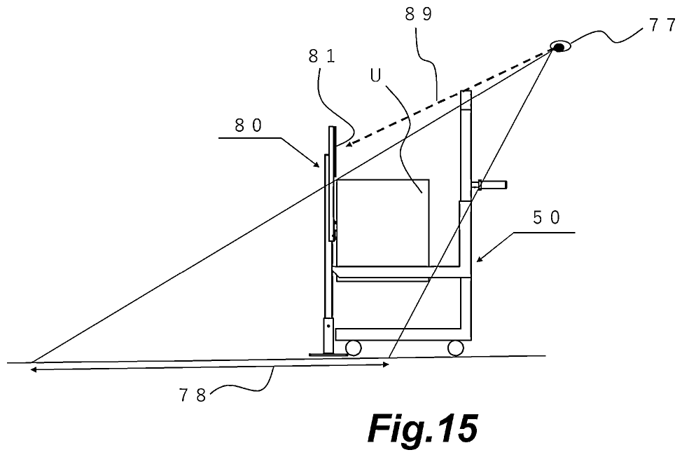

FIG. 15 is a diagram showing a state in which the assisting apparatus 80 and the operator are located on opposite sides of the web roll U, in the same manner as in FIG. 12. The indication portion 81 of the assisting apparatus 80 is configured to be at a position higher than the upper surface of the web roll U in a state in which the largest web roll U that can be placed on the lifting apparatus 50 is at the highest position the lifting apparatus 50 can lift. In the second embodiment, as shown in FIG. 15, there is an invisible area 78 hidden by the web roll U from the operator's viewpoint 77. However, by installing the indication portion 81 at a relatively high position, the operator can directly view the indication portion 81 as indicated by the line of sight 89 so as to determine the height of the web roll U. The operation after completing aligning the height is the same as in the first embodiment.

As in the first embodiment, the use of the assisting apparatus 80 having the configuration of the second embodiment allows the operator to align the height of the web roll U while standing, thereby reducing the physical burden on the operator. Other advantages include a short time to complete the operation and the use of a general-purpose lifter for aligning the height without requiring a dedicated lifter. Furthermore, since the height can be aligned in advance for the next job while printing the current job, the time required to change rolls can be shortened, thereby improving productivity. Unlike the first embodiment, the assisting apparatus does not require a power source such as a battery, thereby simplifying the configuration. Also, there is no need to replace batteries.

### Third Embodiment

A third embodiment is now described. The third embodiment differs from the first and second embodiments in the configuration of the assisting apparatus. Configurations similar to those in the first embodiment or the second embodiment are not shown in drawings, or are given the same reference numerals in the drawings for description.

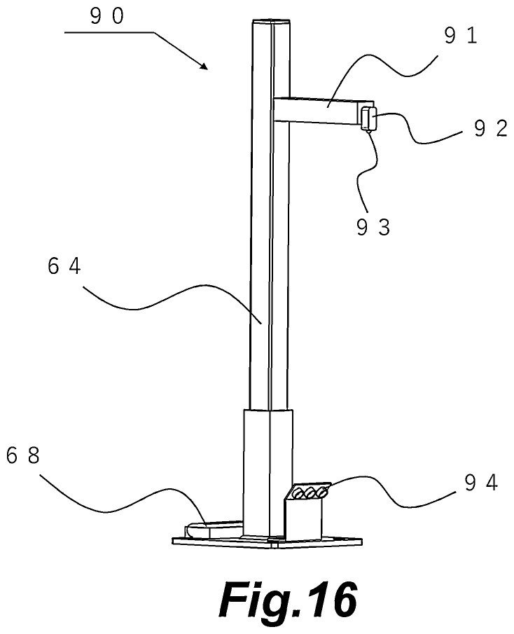

FIG. 16 is a diagram showing an assisting apparatus 90 of the third embodiment. The assisting apparatus 90 may include an arm portion 91, a support column 64, a sensor 92, a light emitting member 94, and a dry battery 68, for example. In the third embodiment, the assisting apparatus 90 is configured to be able to be carried independently of the printing apparatus 1, but the support column 64 may be configured as a part of the printing apparatus 1, for example. The dry battery 68 is mounted as a power source, and a power switch (not shown) is turned on before use. However, the power source is not limited to a dry battery.

The arm portion 91 is a shaft member that is insertable into the winding core 20 of the web roll U. The sensor 92 is a detector that is provided on the arm portion 91 to detect the relative position between the winding core 20 and the arm portion 91 inserted in the winding core 20. The light emitting member 94 is a notifier that provides a notification according to the detection result of the sensor 92. The light emitting member 94 provides a notification when the sensor 92 detects that the relative position between the arm portion 91 and the winding core 20 has reached a predetermined target position.

The arm portion 91 has a substantially horizontal arm shape that is sufficiently thinner than the inner diameter of the winding core 20 so as to be easily inserted into the inner diameter portion of the winding core 20. The arm portion 91 is fixed to the support column 64. The sensor 92 is attached to the distal end of the arm portion 91, and the height of the sensor 92 is set in advance at a position where it can detect that the center height of the web roll U matches the center height of the unwinding shaft 40. The height of the winding core 20 can be measured by a contact detection portion 93 of the sensor 92 coming into contact with the inner circumference surface of the winding core 20 within the winding core 20.

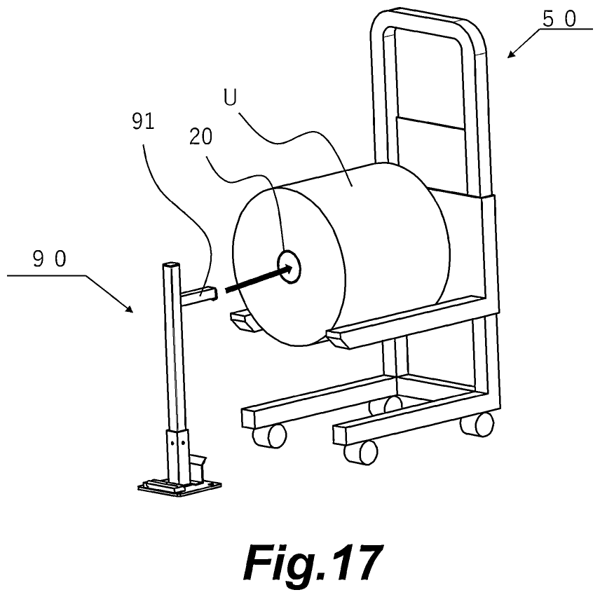

FIG. 17 is a diagram showing a state in which the assisting apparatus 90 of the third embodiment is brought closer to the winding core 20 of the web roll U loaded on the lifting apparatus 50 to be inserted therein. As shown in FIG. 17, with the web roll U placed on the lifting apparatus 50, the height of the lifting apparatus 50 is roughly adjusted so that the arm portion 91 can be inserted into the winding core 20. The assisting apparatus 90 is then set by inserting the arm portion 91 into the winding core 20 as indicated by the arrow. At this time, the horizontal position of the arm portion 91 is preferably set to be as close as possible to the center of the winding core 20. When the height is gradually increased from this state, the contact detection portion 93 of the sensor 92 comes into contact with the inner circumference surface of the winding core 20.

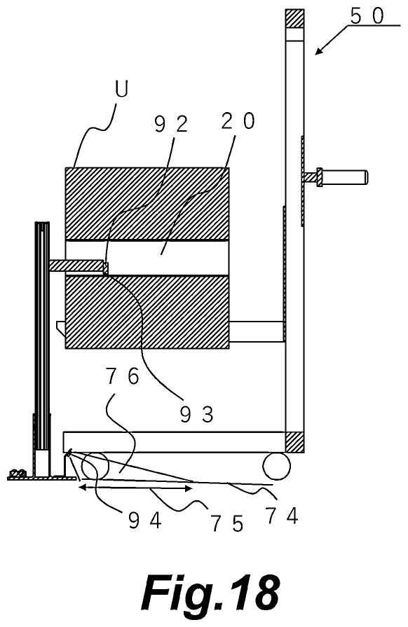

FIG. 18 is a cross-sectional view showing a state in which the contact detection portion 93 of the sensor 92 is in contact with the inner circumference surface of the winding core 20 of the web roll U loaded on the lifting apparatus 50. When the contact detection portion 93 comes into contact with the inner circumference of the winding core 20, the sensor 92 detects the contact and activates the notifier. For example, the position at which the color of the light emitted by LEDs, which form the light emitting member 94, is changed from red to green is the desired height of the web roll U. Alternatively, the position at which the light emitting member 94 is switched from an off state to an on state may be set as the desired height of the web roll U.

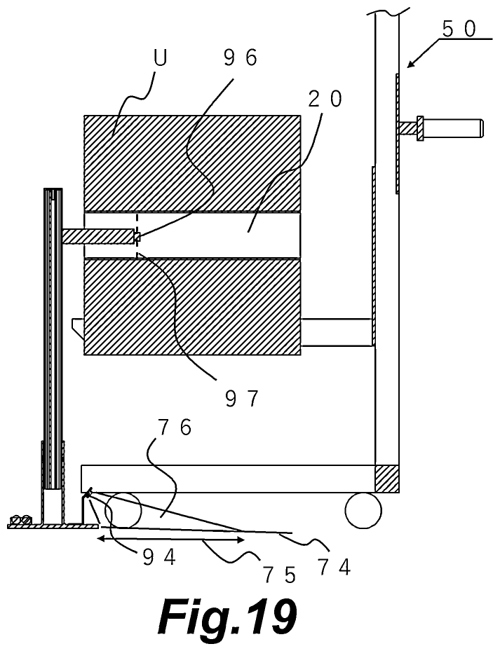

FIG. 19 is a diagram showing another embodiment of the sensor provided on the arm portion 91. In the example of FIG. 19, a non-contact sensor 96 is used to measure the distance to the upper or lower side of the inner circumference surface of the winding core 20 or the distances to both the upper and lower sides using a light beam 97 or the like in a non-contact manner. The light emitting member 94 may emit light when a preset height is detected while the web roll U is moved up and down.

As in the first embodiment, the light emission pattern of the LED serving as the light emitting member 94 may be changed, and it is also preferable to illuminate the floor surface 74, the ceiling (not shown), or a wall surface. This allows the operator to easily visually perceive the illumination area 75 of the illumination light 76. It is also suitable to use a sound emitting member instead of the light emitting member 94. Depending on the detection result of the sensor 92 or the sensor 96, a configuration that emits a buzzer sound or a melody, or a configuration that combines sound and light may also be used. The operation after completing aligning the height is the same as in the first embodiment.

As in the first embodiment, the use of the assisting apparatus having a configuration of the third embodiment allows the operator to align the height of the web roll U while standing, thereby reducing the physical burden on the operator. Other advantages include a short time to complete the operation and the use of a general-purpose lifter for aligning the height without requiring a dedicated lifter. Furthermore, since the height can be aligned in advance for the next job while printing the current job, the time required to change rolls can be shortened, thereby improving productivity. Unlike the first embodiment, this embodiment does not have a slide structure. Nevertheless, it still forms an assisting apparatus that has the same advantageous effects.

### Fourth Embodiment

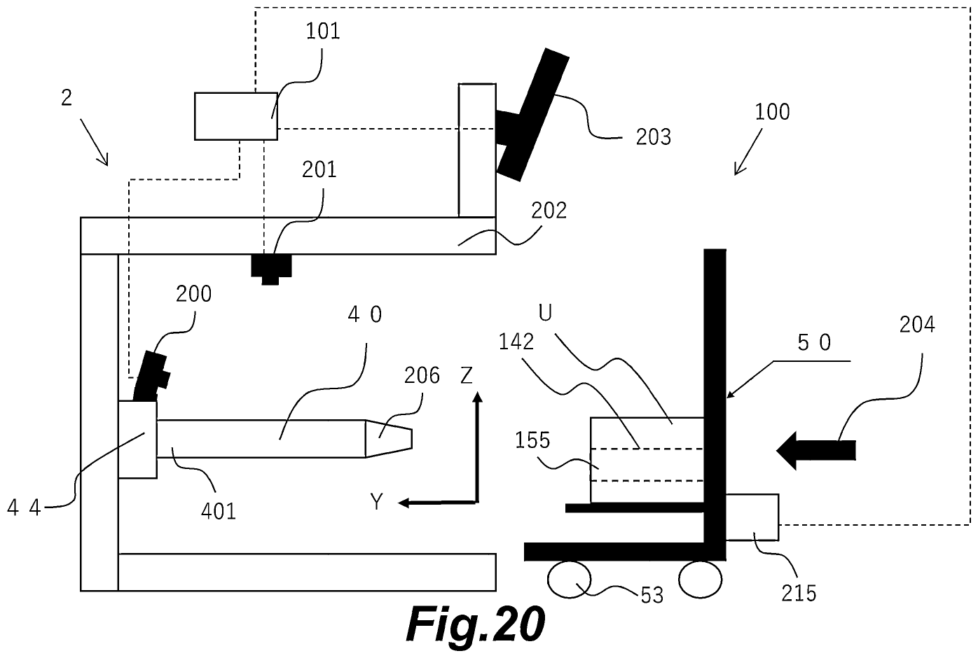

FIG. 20 is a diagram showing the schematic configuration of an assisting apparatus of a fourth embodiment. The unwinder unit 2 includes an unwinding shaft 40, which is a rotation shaft that is insertable into the winding core 142 of a web roll U around which the sheet is wound. The unwinder unit 2 is a roll using apparatus that can use the web roll U in a state in which the web roll U is attached to the unwinding shaft 40. The assisting apparatus 100 assists the operator in aligning the unwinding shaft 40 and the web roll U in the axial and vertical directions of the unwinding shaft 40. A first end portion 401 in the axial direction of the unwinding shaft 40 is rotatably fixed to a bearing 44, and the unwinding shaft 40 is insertable into the web roll U from the side corresponding to the second end portion (the side corresponding to the distal end portion 206) that is opposite to the first end portion 401 in the axial direction. The assisting apparatus 100 includes a camera 200 and a camera 201, which are imager, and a monitor 203, which is a display that displays images captured by the cameras 200 and 201.

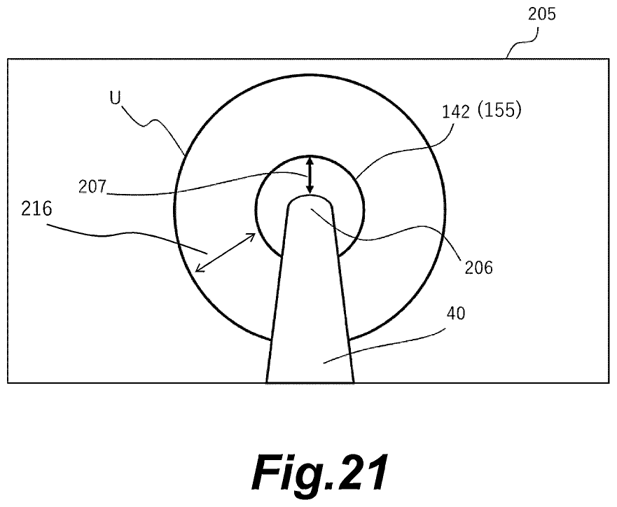

The camera 200 is a first image capturing portion that is arranged such that the distal end portion 206, which is the second end portion, of the unwinding shaft 40 and the end portion 155 in the axial direction of the winding core 142 that is closer to the unwinding shaft 40 are included in a captured image. In the example of a captured image 205 shown in FIG. 21, the upper surface of the distal end portion 206 of the unwinding shaft 40 and the upper end of the winding core 142 are included in the captured image 205. Thus, the presence or absence and the size of a vertical gap 207 between the unwinding shaft 40 and the winding core 142 can be identified. Alternatively, the camera 200 may be arranged such that the lower surface of the distal end portion 206 of the unwinding shaft 40 and the lower end of the winding core 142 are included in the captured image 205.

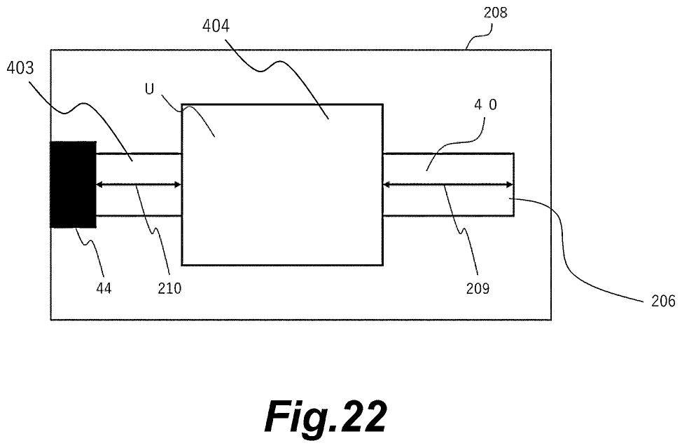

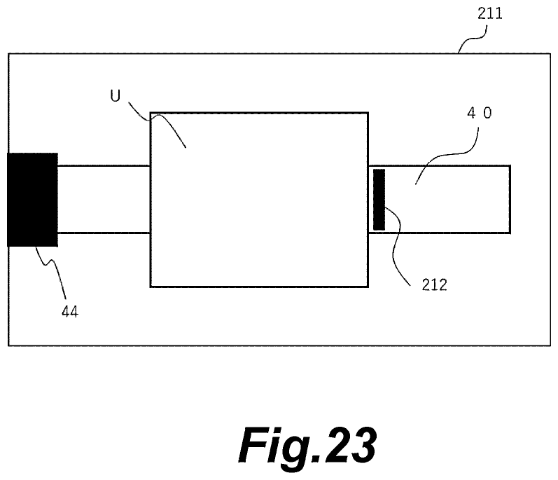

The camera 201 is a second image capturing portion arranged such that the outer circumference surface 403 of the unwinding shaft 40 and the outer circumference surface 404 of the web roll U are included in a captured image. In the example of a captured image 208 shown in FIG. 22, the entire unwinding shaft 40 in the axial direction and the entire web roll U in the axial direction are included in the captured image 208. It is thus possible to identify the distance in the axial direction between the web roll U and the distal end portion 206 of the unwinding shaft 40 and the distance in the axial direction between the web roll U and the bearing 44. The camera 201 may be arranged such that a part of the unwinding shaft 40 and an end portion of the web roll U are included in the captured image 208. Also, as shown in FIG. 23, the unwinding shaft 40 may have a mark 212 indicating the target position of the web roll U in the axial direction. In this case, the camera 201 is arranged such that the mark 212 is included in the captured image 211.

FIG. 20 illustrates an example of a configuration that includes two cameras of the camera 200 and the camera 201 as imager. However, a configuration may be used that includes one of the cameras 200 and 201. A configuration including only the camera 200 can assist the alignment in the vertical direction, whereas a configuration including only the camera 201 can assist the alignment in the axial direction. The imager may be arranged such that the second end portion (distal end portion 206) of the unwinding shaft 40 and the end portion 155 of the winding core 142 are included in the captured image, and that the outer circumference surface 403 of the unwinding shaft 40 and the outer circumference surface 404 of the web roll U are included in the captured image. In this case, one imager may be used to assist in aligning in the vertical and axial directions.

Also, the configuration of the example of FIG. 20 includes one monitor 203 as a display. However, it is also possible to include multiple monitors, including a monitor serving as a first display portion that displays an image captured by the camera 200 and a monitor serving as a second display portion that displays an image captured by the camera 201. Furthermore, the monitor 203 may be detachably attached to a frame 202. In this case, when the monitor 203 fixed to the frame 202 is difficult to visually observe from the operating position of the operator, the monitor 203 can be removed and placed at a location that enables visual observation by the operator.

According to the assisting apparatus 100 of the fourth embodiment, the operator can perform alignment between the unwinding shaft 40 and the winding core 142 of the web roll U in the vertical and axial directions while checking the images on the monitor 203 captured by the camera 200 and the camera 201. This assists in the operation of aligning the height of the web roll U with the unwinding shaft 40 before the operation of attaching the web roll U to the unwinding shaft 40. This further assists the operation of pushing the web roll U to a predetermined target position after starting the insertion of the unwinding shaft 40 into the winding core 142 of the web roll U.

The assisting apparatus 100 may include a detector that detects the relative position of the unwinding shaft 40 and the web roll U in the vertical direction on the basis of an image captured by the camera 200. It may also include a detector that detects the relative position of the unwinding shaft 40 and the web roll U in the axial direction on the basis of an image captured by the camera 201. In the example of FIG. 20, the control portion 101 obtains images captured by the cameras 200 and 201 and detects the relative positions of the unwinding shaft 40 and the web roll U in the vertical direction and the axial direction. For example, the control portion 101 may be configured to determine whether the web roll U is at the target position in the vertical direction and/or the axial direction by performing image processing on the obtained captured image. In this case, the control portion 101 may display the determination result on the monitor 203. This allows the operator to operate the lifting apparatus 50 while checking the determination result displayed on the monitor 203, facilitating the alignment operation of the web roll U.

Furthermore, the control portion 101 may control the operation of the lifting apparatus 50, which is a moving means capable of moving the web roll U in a state in which the web roll U is placed, on the basis of the determination result. In the example of FIG. 20, the lifting apparatus 50 includes a motor 215 as a driving source for lifting and lowering the placed web roll U, and the control portion 101 controls the operation of the motor 215 on the basis of the determination result. For example, when the camera 200 is set such that the upper surface of the unwinding shaft 40 and the upper end of the winding core 142 are within the angle of view as shown in FIG. 21, it may be determined that the gap 207 does not exist as a result of image processing. In this case, the control portion 101 determines that the position of the web roll U is too low, and operates the motor 215 to lift the web roll U on the basis of the determination result. This further simplifies the alignment operation of the web roll U in the vertical direction. In addition, the motor 215 may be configured to be capable of driving the casters 53 of the lifting apparatus 50, and the lifting apparatus 50 may be configured to be capable of moving the web roll U in the axial direction with the driving force of the motor 215. In this case, the movement of the web roll U in the axial direction can be controlled on the basis of the determination result of the relative position between the web roll U and the unwinding shaft 40 obtained by the control portion 101 through image processing. This further simplifies the alignment operation of the web roll U in the axial direction.

Also, the control portion 101 may detect the remaining amount of the web roll U on the basis of an image captured by the imager. For example, the control portion 101 may determine the remaining amount of the web roll U by performing image processing on the captured image 205 captured by the camera 200 shown in FIG. 21 to detect the winding diameter 216 of the web roll U.

In the fourth embodiment, when the control portion 101 does not perform image processing or control of the lifting apparatus 50, images captured by the cameras 200 and 201 may be directly output to the monitor 203. In this case, the assisting apparatus 100 does not include the control portion 101. Furthermore, the lifting apparatus 50 may have a configuration in which the web roll U is manually lifted and lowered by the operator operating an operating portion such as a handle. In this case, the lifting apparatus 50 does not include the motor 215.

The assisting apparatus 100 includes the camera 200 installed on the bearing 44, the camera 201 installed on the frame 202 of the unwinder unit 2, and the monitor 203 located at a position that is visually perceivable by the operator who operates the lifting apparatus 50 from the direction of arrow 204. The assisting apparatus 100 includes the control portion 101 that obtains images captured by the camera 200 and the camera 201 and outputs the obtained images to the monitor 203. The control portion 101 may also perform image processing on the captured image and outputs the image processing result to the monitor 203. Additionally, the control portion 101 controls the motor 215, which is a driving source included in the lifting apparatus 50, on the basis of the image processing result. The camera 200 in FIG. 20 captures the position of the web roll in the height direction (Z direction), and the camera 201 captures the position of the web roll in the depth direction (Y direction).

In FIG. 20, the camera 200 is installed on the bearing 44, and the camera 201 is installed on the frame 202 so as to capture the unwinding shaft 40 from above. A total of two cameras are used. However, the installation positions and the number of cameras are not limited to those shown in FIG. 20, provided that the image capturing conditions described below are satisfied.

The image capturing conditions are now described. FIG. 21 illustrates a captured image 205 captured by the camera 200 for checking the height of the web roll U. To set the winding core 142 of the web roll U to a height that allows the insertion of the unwinding shaft 40, the distal end portion 206 of the unwinding shaft 40 on the side corresponding to the web roll U and the winding core 142 need to appear in the captured image 205 captured by the camera 200. The image capturing condition for checking the height of the web roll U is that the camera 200 is arranged such that the vertical gap 207 between the distal end portion 206 of the unwinding shaft 40 and the winding core 142 can be seen. When the vertical gap 207 is within a specified range, it may be considered that the height of the winding core 142 is higher than the distal end portion 206 of the unwinding shaft 40 and the outer circumference of the unwinding shaft 40 is on the inner side of the winding core 142. In this state, the unwinding shaft 40 can be inserted into the web roll U.

The image capturing condition for checking depth is now described. There are two methods to align the depth. One method is to align the axial centers of the web roll U and the unwinding shaft 40. The other method is to align the distal end of the web roll U with a predetermined mark on the unwinding shaft 40.

First, the image capturing conditions for aligning the axial centers of the web roll U and the unwinding shaft 40 are described. FIG. 22 is an example of a captured image 208 captured by the camera 201 in FIG. 20 for checking the depth position of the web roll U. The image capturing conditions required to align the axial center of the web roll U with the axial center of the unwinding shaft 40 include that both axial ends of the web roll U appear in the captured image 208. The image capturing conditions also include that the distance 210 between the web roll U and the bearing 44 and the distance 209 between the web roll U and the distal end portion 206 of the unwinding shaft 40 appear in the captured image 208. When the distance 210 to the bearing 44 and the distance 209 to the distal end portion 206 can be visually checked using the captured image 208, it is possible to align the axial centers of the web roll U and the unwinding shaft 40.

The image capturing condition for aligning the distal end of the web roll U with a predetermined mark on the unwinding shaft 40 is now described. FIG. 23 is an example of a captured image 211 captured by the camera 201 in FIG. 20 for checking the depth position of the web roll U.

A mark 212 is located on the unwinding shaft 40 and indicates the installation position of the end of the web roll U. Although it is simply indicated by a black line in the figure, there may be multiple lines according to the width of the web roll U, or there may be a scale. Also, the mark 212 may be on the side corresponding to the bearing 44.

The image capturing condition for aligning the axial position of the web roll U is that one of the axial ends of the web roll U and the mark 212 are both captured. When one of the axial ends of the web roll U and the mark 212 can both be visually checked, the web roll U can be installed at a predetermined position regardless of its length in the axial direction.

### Fifth Embodiment

A fifth embodiment is now described. The fifth embodiment differs from the fourth embodiment in the configuration of the height and depth notification mechanism. Configurations similar to those in the fourth embodiment are not shown in drawings, or are given the same reference numerals in the drawings for description. As for the means for aligning the height and the depth direction, the means for aligning the height is first described.

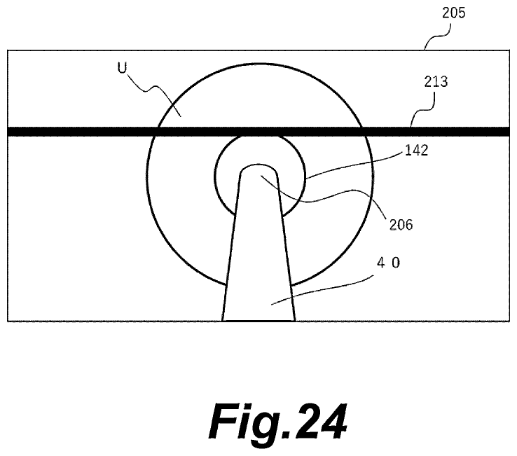

FIG. 24 is an example of a captured image 205 captured by the camera 200. The difference from FIG. 21 is that an indication line 213, which is an assistance image for aligning the height of the winding core 142, is displayed in the captured image 205 captured by the camera 200. This indication line 213 is only displayed in the captured image 205 and does not physically exist. The indication line 213 is displayed at a position that causes the height of the web roll U to be aligned with the unwinding shaft 40. For example, as shown in FIG. 24, the indication line 213 may be positioned such that the height of the web roll U is aligned when the outer circumference of the winding core 142 coincides with the indication line 213. This increases the ease of operation. There may be multiple indication lines 213, and the shape does not need to be a straight line.

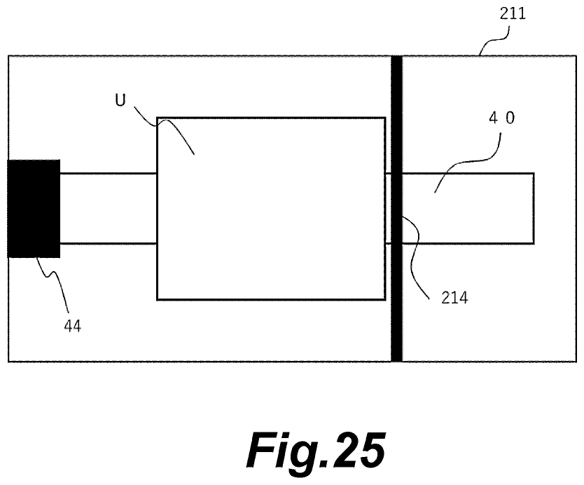

A process of aligning the depth direction is now explained. FIG. 25 is an example of a captured image 211 captured by the camera 201. The difference from FIG. 23 is that an indication line 214, which is an assistance image for aligning the position of the web roll U in the axial direction, is displayed in the captured image 211 captured by the camera 201. This indication line 214 is only displayed in the captured image 211 and does not physically exist. The indication line 214 is displayed at a position that causes the axial position of the web roll U to be aligned with a predetermined position of the unwinding shaft 40. For example, as shown in FIG. 25, the indication line 214 may be positioned such that the axial position of the web roll U is aligned when an end of the web roll U coincides with the indication line 214. This increases the ease of operation. There may be multiple indication lines 214 according to the width of the web roll U, and the shape does not need to be straight.

According to the present disclosure, an assisting apparatus is provided that simplifies the operation of position adjustment when a roll is attached to a rotation shaft of a roll using apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-099530, filed on Jun. 16, 2023, which is hereby incorporated by reference herein in its entirety.

What is claimed is:

1. An assisting apparatus comprising:
a shaft member that is insertable into a winding core of a roll around which a sheet is wound;
a moving member movable in a vertical direction, the moving member including the shaft member; and
a detector configured to detect a position of the moving member in the vertical direction, wherein
the assisting apparatus is configured to assist in an operation of aligning a position of the roll in the vertical direction in a state in which the shaft member is inserted in the winding core, and
the assisting apparatus further comprises a notifier configured to provide a notification when the detector detects that the position of the moving member in the vertical direction reaches a predetermined target position.

2. The assisting apparatus according to claim 1, wherein
the roll is usable in a state in which the roll is attached to a rotation shaft of a roll using apparatus including the rotation shaft that is insertable into the winding core, and
when the moving member is at the target position, an inner circumference surface of the winding core of the roll and an outer circumference surface of the rotation shaft do not interfere with each other.

3. The assisting apparatus according to claim 1, wherein the notifier includes a light emitting member and is configured to provide a notification by light.

4. The assisting apparatus according to claim 3, wherein the notifier is configured to provide a notification by applying light with the light emitting member to a wall surface, a ceiling, or a floor surface of a space in which the assisting apparatus is set.

5. The assisting apparatus according to claim 3, wherein
the light emitting member is capable of emitting light in a plurality of different colors, and
the notifier is configured to provide a notification by causing the light emitting member to emit light in different colors between a state in which the position of the moving member is at the target position and another state.

6. The assisting apparatus according to claim 3, wherein
the light emitting member is capable of emitting light in a plurality of different patterns, and
the notifier is configured to provide a notification by causing the light emitting member to emit light in different patterns between a state in which the position of the moving member is at the target position and another state.

7. The assisting apparatus according to claim 1, wherein the notifier includes a sound emitting member and is configured to provide a notification by sound.

8. The assisting apparatus according to claim 1, wherein the shaft member has a tapered shape with an outer diameter increasing in a direction in which the shaft member is inserted into the winding core.

9. The assisting apparatus according to claim 1, wherein the shaft member has a stepped shape including a plurality of sections with different outer diameters.

10. The assisting apparatus according to claim 1, wherein the detector is configured to detect a state in which the position of the moving member is at the target position, a state in which the moving member is at a position higher than the target position, and a state in which the moving member is at a position lower than the target position.

11. The assisting apparatus according to claim 10, wherein
the detector includes a first photo interrupter and a second photo interrupter that are at different positions in the vertical direction,
the moving member includes a blocking portion that is capable of blocking between a light emitting portion and a light receiving portion of the first photo interrupter or blocking between a light emitting portion and a light receiving portion of the second photo interrupter depending on a position in the vertical direction,
a length of the blocking portion in the vertical direction is less than a distance in the vertical direction between the first photo interrupter and the second photo interrupter,
the blocking portion is configured so as not to block either the first photo interrupter or the second photo interrupter when the moving member is at the target position, and
the blocking portion is configured to block one of the first photo interrupter and the second photo interrupter in a state in which the moving member is at a position higher than the target position and a state in which the moving member is at a position lower than the target position.

12. The assisting apparatus according to claim 1, wherein
the shaft member is configured to be inserted into the winding core of the roll placed on a lifting apparatus that is capable of moving the roll in the vertical direction, and
the assisting apparatus is configured independently of the lifting apparatus.

13. An assisting apparatus comprising:
a shaft member that is insertable into a winding core of a roll around which a sheet is wound;
a moving member movable in a vertical direction, the moving member including the shaft member;
a support member that supports the moving member such that the moving member is movable in the vertical direction; and
an indicator configured to indicate a position of the moving member in the vertical direction by moving in conjunction with movement of the moving member, wherein
the assisting apparatus is configured to assist in an operation of aligning a position of the roll in the vertical direction in a state in which the shaft member is inserted in the winding core, and
the indicator includes a mark that enables visual identification that the position of the moving member in the vertical direction reaches a predetermined target position.

14. The assisting apparatus according to claim 13, wherein
the roll is usable in a state in which the roll is attached to a rotation shaft of a roll using apparatus including the rotation shaft that is insertable into the winding core, and
when the moving member is at the target position, an inner circumference surface of the winding core of the roll and an outer circumference surface of the rotation shaft do not interfere with each other.

15. The assisting apparatus according to claim 13, wherein
the mark includes a first mark provided on the moving member and a second mark that does not move relative to the support member, and
the first mark and the second mark are configured to be aligned in position when the moving member is at the target position.

16. The assisting apparatus according to claim 15, wherein
the mark includes:
a third mark extending in the vertical direction and indicating a region of the moving member that is higher than the first mark; and
a fourth mark extending in the vertical direction and indicating a region of the moving member that is lower than the first mark,
the second mark is configured to be in a range of the fourth mark when the moving member is at a position higher than the target position, and
the second mark is configured to be in a range of the third mark when the moving member is at a position lower than the target position.

17. The assisting apparatus according to claim 13, wherein the indicator is located at a position higher than a height of an upper surface of a largest roll that can be placed on a lifting apparatus that is capable of moving the roll in the vertical direction in a state in which the roll is at a highest position the lifting apparatus can lift.

18. The assisting apparatus according to claim 13, wherein
the shaft member is configured to be inserted into the winding core of the roll placed on a lifting apparatus that is capable of moving the roll in the vertical direction, and
the assisting apparatus is configured independently of the lifting apparatus.

19. An assisting apparatus comprising:
a shaft member that is insertable into a winding core of a roll around which a sheet is wound; and
a detector configured to detect a relative position between the winding core and the shaft member inserted in the winding core, the detector including the shaft member, wherein
the assisting apparatus is configured to assist in an operation of aligning a position of the roll in the vertical direction in a state in which the shaft member is inserted in the winding core, and
the assisting apparatus further comprises a notifier configured to provide a notification when the detector detects that the relative position between the shaft member and the winding core reaches a predetermined target position.

20. The assisting apparatus according to claim 19, wherein
the roll is usable in a state in which the roll is attached to a rotation shaft of a roll using apparatus including the rotation shaft that is insertable into the winding core, and
when the relative position between the winding core and the shaft member is at the target position, an inner circumference surface of the winding core and an outer circumference surface of the rotation shaft do not interfere with each other.

21. An assisting apparatus configured to assist in an operation of aligning positions in a vertical direction of a rotation shaft of a roll using apparatus and a roll, the rotation shaft being insertable into a winding core of the roll around which a sheet is wound, the roll using apparatus being capable of using the roll in a state in which the roll is attached to the rotation shaft, wherein
a first end portion of the rotation shaft in an axial direction is fixed to the roll using apparatus, the rotation shaft is insertable into the roll from a side corresponding to a second end portion that is opposite to the first end portion in the axial direction of the rotation shaft,
the assisting apparatus comprises:
an imager; and
a display configured to display a captured image captured by the imager, wherein
the imager is arranged such that images of the second end portion of the rotation shaft and an end portion of the winding core in an axial direction that is closer to the rotation shaft are included in the captured image.

22. The assisting apparatus according to claim 21, wherein the imager is arranged such that images of an upper surface of the second end portion of the rotation shaft and an upper end of the winding core are included in the captured image.

23. The assisting apparatus according to claim 21, wherein the imager is arranged such that images of a lower surface of the second end portion of the rotation shaft and a lower end of the winding core are included in the captured image.

24. A recording apparatus configured to perform recording on a sheet comprising:
a rotation shaft that is insertable into a winding core of a roll around which the sheet is wound; and
an assisting apparatus, wherein
the roll is usable in a state in which the roll is attached to the rotation shaft of the recording apparatus,
the assisting apparatus comprising:
a shaft member that is insertable into the winding core of the roll around;
a moving member movable in a vertical direction, the moving member including the shaft member;
a detector configured to detect a position of the moving member in the vertical direction; and
a notifier configured to provide a notification when the detector detects that the position of the moving member in the vertical direction reaches a predetermined target position, wherein
the assisting apparatus is configured to assist in an operation of aligning a position of the roll in the vertical direction in a state in which the shaft member is inserted in the winding core, and
when the moving member is at the target position, an inner circumference surface of the winding core of the roll and an outer circumference surface of the rotation shaft do not interfere with each other.
